(19) United States
(12) Patent Application Publication
(10) Pub. No.: US 2017/0295578 A1
(43) Pub. Date: Oct. 12, 2017

(54) BANDWIDTH EXPANSION IN CHANNEL COEXISTENCE

(71) Applicant: QUALCOMM Incorporated, San Diego, CA (US)

(72) Inventors: Mostafa KHOSHNEVISAN, San Diego, CA (US); Satashu GOEL, San Diego, CA (US); Farhad MESHKATI, San Diego, CA (US); Damanjit SINGH, San Diego, CA (US); Vinay JOSEPH, San Diego, CA (US)

(21) Appl. No.: 15/477,935

(22) Filed: Apr. 3, 2017

Related U.S. Application Data
(60) Provisional application No. 62/359,668, filed on Jul. 7, 2016.
(60) Provisional application No. 62/319,249, filed on Apr. 6, 2016.

(51) Int. Cl. H04W 72/04; H04W 52/24; H04W 72/08; H04W 28/02; H04L 5/00

(52) U.S. Cl. CPC H04W 72/0486; H04W 28/0252; H04L 5/0032; H04W 72/082; H04W 72/048; H04W 52/243

(57) ABSTRACT

Aspects of the present disclosure relate to methods and apparatus for bandwidth expansion in channel co-existence situations. An example method generally includes determining information regarding loading of at least one of downlink (DL) or uplink (UL traffic at a first base station that can share at least some bandwidth with at least one neighbor base station, and modifying bandwidth of one or more channels used by the first base station based, at least in part, on the loading information.

### CROSS-REFERENCE TO RELATED CASES

This application claims benefit of U.S. Provisional Patent Application Ser. No. 62/319,249, entitled “Bandwidth Expansion in Channel Coexistence,” filed Apr. 6, 2016, and U.S. Provisional Patent Application Ser. No. 62/359,668, entitled “Interference Maps for Efficient Spectrum Sharing,” filed Jul. 7, 2016, both of which are assigned to the assignee hereof and both of which are herein incorporated by reference in their entirety.

### BACKGROUND

### Field of the Disclosure

Certain aspects of the present disclosure generally relate to wireless communications and, more particularly, to techniques for bandwidth expansion in co-channel coexistence.

### Description of Related Art

Wireless communication systems are widely deployed to provide various types of communication content such as voice, data, video, and the like, and deployments are likely to increase with introduction of new data oriented systems such as Long Term Evolution (LTE) systems. Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and other orthogonal frequency division multiple access (OFDMA) systems.

Generally, a wireless multiple-access communication system can simultaneously support communication for multiple wireless terminals (also known as user equipments (UEs), user terminals, or access terminals (ATs)). Each terminal communicates with one or more base stations (also known as access points (APs), eNodeBs, or eNBs) via transmissions on forward and reverse links. The forward link (also referred to as a downlink or DL) refers to the communication link from the base stations to the terminals, and the reverse link (also referred to as an uplink or UL) refers to the communication link from the terminals to the base stations. These communication links may be established via single-in-single-out, single-in-multiple out, multiple-in-single-out, or multiple-in-multiple-out (MIMO) systems.

Newer multiple access systems, for example, LTE, deliver faster data throughput than older technologies. Faster downlink rates, in turn, have sparked a greater demand for higher-bandwidth content, such as high-resolution graphics and video, for use on or with mobile devices. Therefore, demand for bandwidth on wireless communications systems continues to increase despite availability of higher data throughput over wireless interfaces, and this trend is likely to continue. However, wireless spectrum is a limited and regulated resource. Therefore, new approaches are needed in wireless communications to more fully utilize this limited resource and satisfy consumer demand.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “DETAILED DESCRIPTION” one will understand how the features of this disclosure provide advantages that include improved communications between access points and stations in a wireless network.

Certain aspects of the present disclosure generally relate to techniques for sharing channels with multiple operators in the case of co-channel coexistence.

Certain aspects of the present disclosure provide a method, performed by a network entity. The method generally includes determining information regarding loading of at least one of downlink (DL) or uplink (UL) traffic at a first base station that can share at least some bandwidth with at least one neighbor base station; and modifying bandwidth of one or more channels used by the first base station based, at least in part, on the loading information.

Certain aspects of the present disclosure provide a method for managing interference between network operators. The method generally includes identifying at least a first frequency spectrum assigned to a first operator and a second frequency spectrum assigned to a second operator, identifying, based on information regarding interference between devices using the first and second frequency spectrums, at least a portion of the second frequency spectrum available for use by a base station of the first operator, and providing an indication of the portion to a base station of the first operator.

Certain aspects of the present disclosure provide a method for wireless communication. The method generally includes communicating using a first frequency spectrum assigned to the first operator, determining at least a portion of a second frequency spectrum assigned to the second operator that is available for use by the base station, and communicating using the portion of the second frequency spectrum.

Numerous other aspects are provided including methods, apparatus, systems, computer program products, computer-readable medium, and processing systems. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram illustrating an example of a network architecture, in accordance with certain aspects of the disclosure.

FIG. 2 is a diagram illustrating an example of an access network, in accordance with certain aspects of the disclosure.

FIG. 3 is a diagram illustrating an example of a DL frame structure in LTE, in accordance with certain aspects of the disclosure.

FIG. 4 is a diagram illustrating an example of an UL frame structure in LTE, in accordance with certain aspects of the disclosure.

FIG. 5 is a diagram illustrating an example of a radio protocol architecture for the user and control plane, in accordance with certain aspects of the disclosure.

FIG. 6 is a diagram illustrating an example of an evolved Node B and user equipment in an access network, in accordance with certain aspects of the disclosure.

FIG. 7 is a block diagram showing aspects of an Authorized Shared Access (ASA) controller coupled to different wireless communication systems including one primary user and one secondary user, in accordance with certain aspects of the disclosure.

FIG. 8 is a block diagram showing aspects of an ASA controller coupled to different wireless communication systems including one primary user and multiple secondary users, in accordance with certain aspects of the disclosure.

FIG. 9 illustrates an example architecture of a spectrum sharing system, in accordance with certain aspects of the disclosure.

FIG. 10 illustrates example operations for modifying a bandwidth of one or more channels used by a base station based on downlink (DL) and/or uplink (UL) loading information for the base station, in accordance with certain aspects of the disclosure.

FIG. 11 illustrates an example bandwidth deployment with a plurality of base stations having a primary channels and a plurality of secondary channels that can be allocated to one or more base stations, in accordance with certain aspects of the disclosure.

FIG. 12 illustrates an example general authorized access (GAA) coexistence scenario, in accordance with certain aspects of the present disclosure.

FIG. 13 illustrates example bandwidth expansion at a base station/Citizens Broadband Radio Service Device (CBSD), in accordance with certain aspects of the present disclosure.

FIG. 14 illustrates example operations that may be performed by a network entity to manage interference between network operators, in accordance with certain aspects of the present disclosure.

FIG. 15 illustrates example operations that may be performed by a base station to communicate on an expanded bandwidth including frequency spectrum assigned to multiple operators, in accordance with certain aspects of the present disclosure.

FIG. 16 illustrates an example message call flow between a Citizens Broadband Radio Service Device (CBSD) and a collocated spectrum access system (SAS)/coexistence manager (CCM) for establishing and transmitting on an expanded bandwidth based on a transmission power map, in accordance with certain aspects of the present disclosure.

FIG. 17 illustrates an example message call flow between a Citizens Broadband Radio Service Device (CBSD), a spectrum access system (SAS), and a coexistence manager (CXM) for establishing and transmitting on an expanded bandwidth based on a transmission power map, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide techniques for expanding and shrinking a bandwidth used by a base station in situations where, for example, a number of available channels exceeds a number of base stations in a location. By expanding and shrinking a bandwidth used by a base station, base stations can modify the bandwidth on which the base station operates to accommodate changes in traffic loading over time. For example, a base station can expand bandwidth to include a secondary channel to accommodate increased uplink (UL) and/or downlink (DL) loading at the base station. The base station can also shrink bandwidth by releasing a secondary channel to other base stations to accommodate decreased traffic loading at the base station (and potentially accommodate increased traffic loading at a neighbor base station).

Aspects of the present disclosure further provide techniques for using interference information for efficient spectrum sharing (e.g., bandwidth shrinking or expansion) in a network. By using interference data to determine portions of a bandwidth of another operator that can be used by a base station of a first operator, base stations can modify the bandwidth on which the base station operates to take advantage of unused spectrum in a given area. For example, a base station can expand bandwidth to include unused bandwidth (spectrum) allocated to another base station within the base station's interference zone and/or bandwidth allocated to another base station outside of the base station's interference zone. By using interference information for bandwidth expansion, base stations can efficiently use, for example, a generally accessible frequency spectrum without causing interference to other base stations operating within the frequency spectrum.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as universal terrestrial radio access (UTRA), cdma2000, etc. UTRA includes wideband CDMA (WCDMA), time division synchronous CDMA (TD-SCDMA), and other variants of CDMA. cdma2000 covers IS-2000, IS-95 and IS-856 standards. A TDMA network may implement a radio technology such as global system for mobile communications (GSM). An OFDMA network may implement a radio technology such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE/LTE-Advanced, and LTE/LTE-Advanced terminology is used in much of the description below. LTE and LTE-A are referred to generally as LTE.

A wireless communication network may include a number of base stations that can support communication for a number of wireless devices. Wireless devices may include user equipments (UEs). Some examples of UEs may include cellular phones, smart phones, personal digital assistants (PDAs), wireless modems, handheld devices, tablets, laptop computers, netbooks, smartbooks, ultrabooks, wearables (e.g., smart watch, smart bracelet, smart glasses, smart ring, smart clothing), etc.

System designs may support various time-frequency reference signals for the downlink and uplink to facilitate beamforming and other functions. A reference signal is a signal generated based on known data and may also be referred to as a pilot, preamble, training signal, sounding signal, and the like. A reference signal may be used by a receiver for various purposes such as channel estimation, coherent demodulation, channel quality measurement, signal strength measurement, and the like. MIMO systems using multiple antennas generally provide for coordination of sending of reference signals between antennas; however, LTE systems do not in general provide for coordination of sending of reference signals from multiple base stations or eNBs.

In some implementations, a system may use time division duplexing (TDD). For TDD, the downlink and uplink share the same frequency spectrum or channel, and downlink and uplink transmissions are sent on the same frequency spectrum. The downlink channel response may thus be correlated with the uplink channel response. Reciprocity may allow a downlink channel to be estimated based on transmissions sent via the uplink. These uplink transmissions may be reference signals or uplink control channels (which may be used as reference symbols after demodulation). The uplink transmissions may allow for estimation of a space-selective channel via multiple antennas.

In LTE implementations, orthogonal frequency division multiplexing (OFDM) is used for the downlink—that is, from a base station, access point or eNodeB (eNB) to a user terminal or UE. Use of OFDM meets the LTE requirement for spectrum flexibility and enables cost-efficient solutions for very wide carriers with high peak rates, and is a well-established technology. For example, OFDM is used in standards such as IEEE 802.11a/g, 802.16, High Performance Radio LAN-2 (HIPERLAN-2, wherein LAN stands for Local Area Network) standardized by the European Telecommunications Standards Institute (ETSI), Digital Video Broadcasting (DVB) published by the Joint Technical Committee of ETSI, and other standards.

Time frequency physical resource blocks (also denoted here in as resource blocks or “RBs” for brevity) may be defined in OFDM systems as groups of transport carriers (e.g., sub-carriers) or intervals that are assigned to transport data. The RBs are defined over a time and frequency period. Resource blocks are comprised of time-frequency resource elements (also denoted here in as resource elements or “REs” for brevity), which may be defined by indices of time and frequency in a slot. Additional details of LTE RBs and REs are described in the 3GPP specifications, such as, for example, 3GPP TS 36.211.

UMTS LTE supports scalable carrier bandwidths from 20 MHz down to 1.4 MHZ. In LTE, an RB is defined as 12 sub-carriers when the subcarrier bandwidth is 15 kHz, or 24 sub-carriers when the sub-carrier bandwidth is 7.5 kHz. In an exemplary implementation, in the time domain there is a defined radio frame that is 10 ms long and consists of 10 subframes of 1 millisecond (ms) each. Every subframe consists of 2 slots, where each slot is 0.5 ms. The subcarrier spacing in the frequency domain in this case is 15 kHz. Twelve of these subcarriers together (per slot) constitute an RB, so in this implementation one resource block is 180 kHz. Six Resource blocks fit in a carrier of 1.4 MHz and 100 resource blocks fit in a carrier of 20 MHz.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer-readable medium for execution on a processor or computer. Furthermore, an aspect may comprise at least one element of a claim.

It is noted that while aspects may be described herein using terminology commonly associated with 3G and/or 4G wireless technologies, aspects of the present disclosure can be applied in other generation-based communication systems, such as 5G and later.

### An Example Wireless Communications System

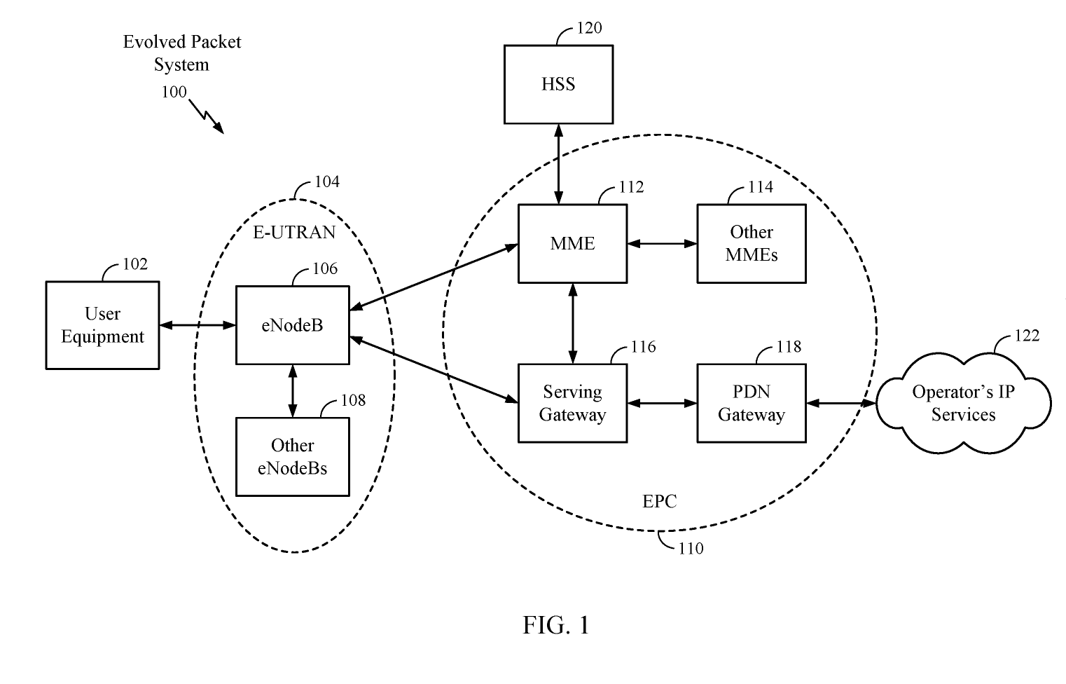

FIG. 1 is a diagram illustrating an LTE network architecture 100 in which aspects of the present disclosure may be practiced. For example, a central entity (not shown) receives information regarding at least uplink (UL) and/or downlink (DL) traffic loading at a plurality of base stations, BS (e.g., eNBs 106 and 108). The central entity determines bandwidth modifications for a first BS based, at least in part, on the UL and/or DL traffic loading at the first BS. In some cases, bandwidth modifications may be further based on UL and/or DL traffic loading at neighbor base stations and interference information reported by a UE on one or more channels. In certain aspects, the role of the central entity may be performed by any node in the network 100, or by an independent entity.

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, a drone, a robot, a sensor, a monitor, a meter, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMES 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

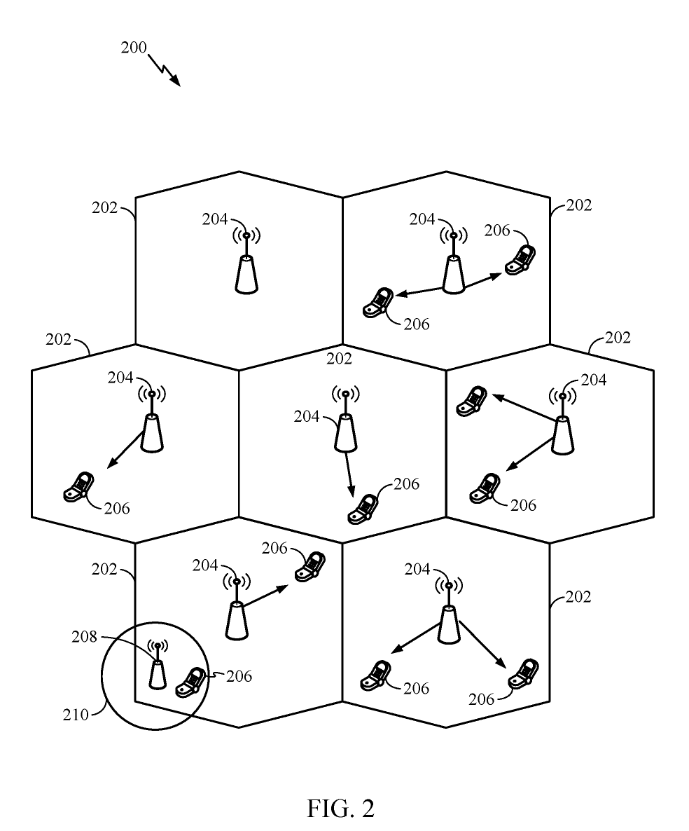

FIG. 2 is a diagram illustrating an example of an access network 200 in an LTE network architecture in which aspects of the present disclosure may be practiced. For example, a central entity (not shown) may be configured to implement techniques for determining bandwidth modification (e.g., expansion and/or shrinkage) for one or more eNBs in the network 200, in accordance with certain aspects of the present disclosure.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

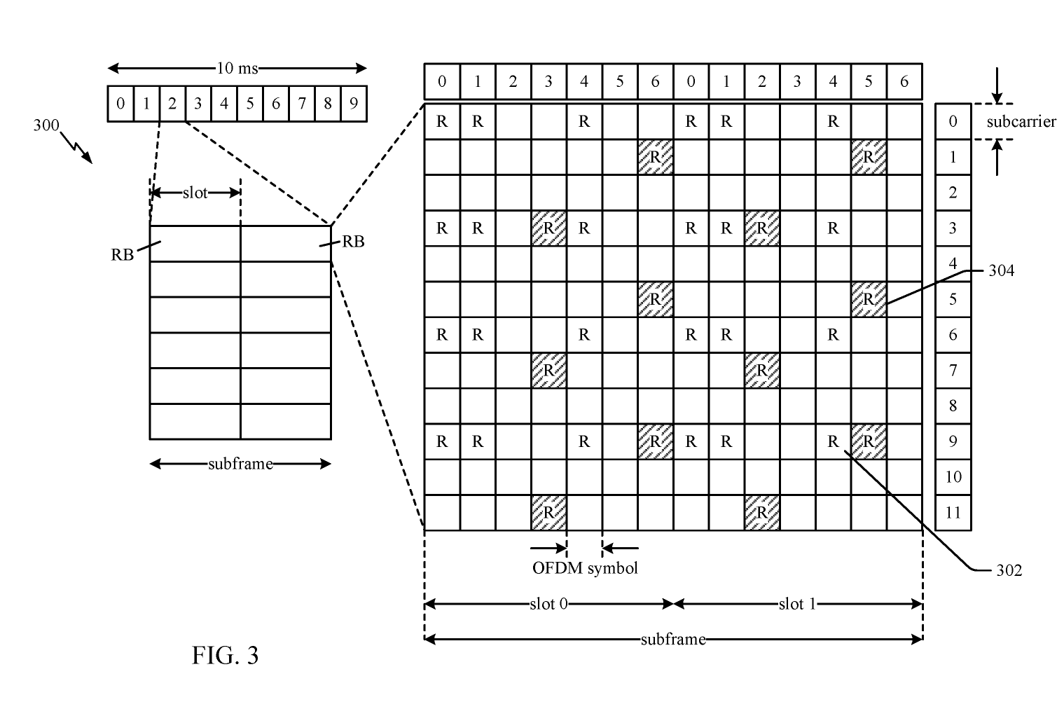

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

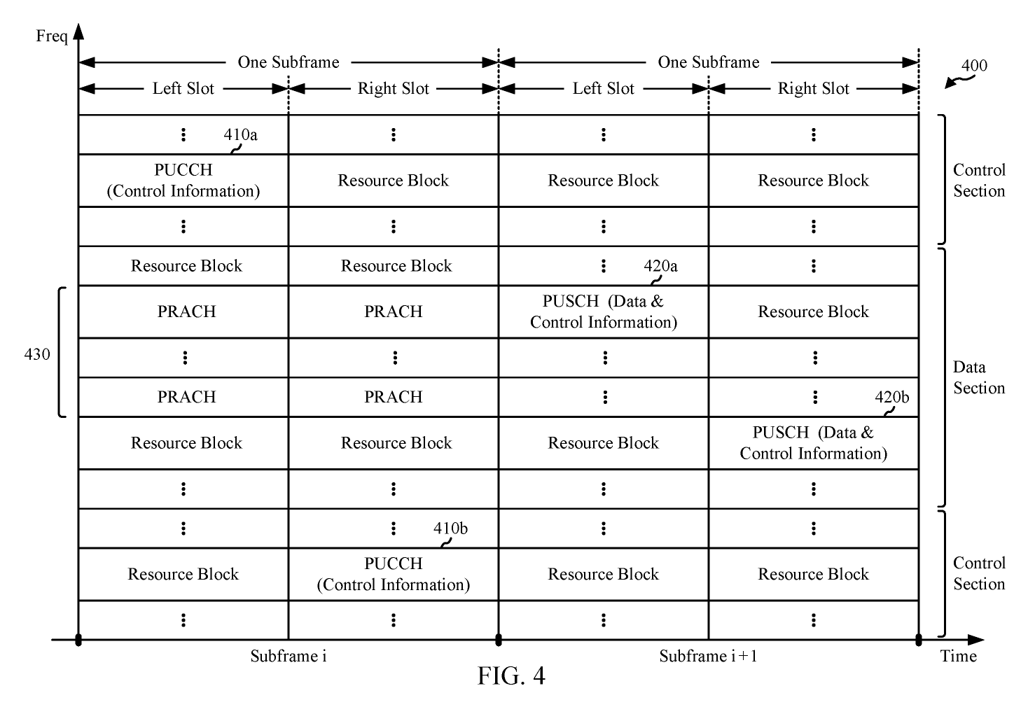

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

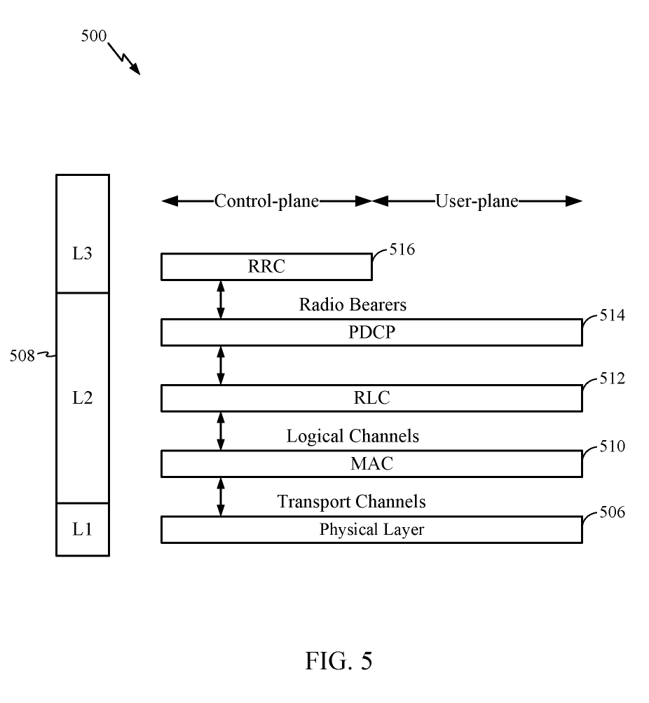

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

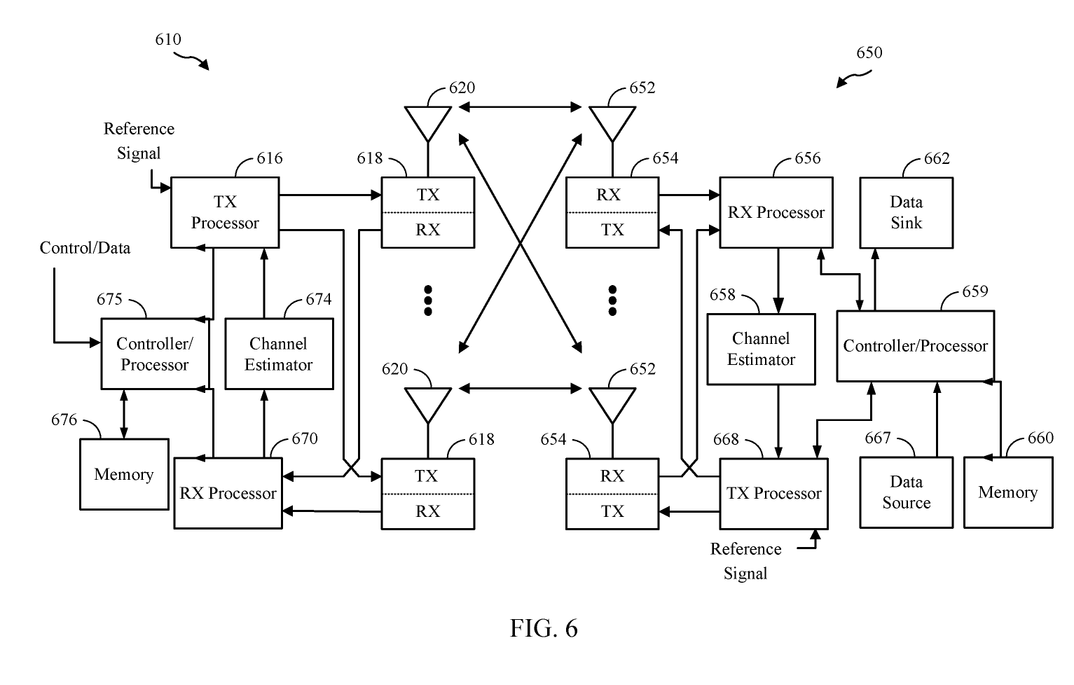

FIG. 6 is a block diagram of an eNB 610 in communication with a UE 650 in an access network, in which aspects of the present disclosure may be practiced. For example, a central entity (not shown) may receive information regarding uplink (UL) and/or downlink (DL) traffic loading and interference information for a plurality of base stations, BS (e.g., eNB 610). The central entity determines bandwidth modification (e.g., bandwidth expansion or shrinkage) for a base station based, at least in part, on UL and/or DL traffic loading for the base station. It may be noted that the central entity may be implemented by eNB 610 or UE 650.

In the DL, upper layer packets from the core network are provided to a controller/processor 675. The controller/processor 675 implements the functionality of the L2 layer, for example. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer), for example. The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer, for example. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer, for example. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659, for example. The data source 667 represents all protocol layers above the L2 layer, for example. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610, for example. The controller/processor 659 is also responsible for HARQ operations, retransmission of lost packets, and signaling to the eNB 610, for example.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer, for example.

The controller/processor 675 implements the L2 layer, for example. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operations at the eNB 610 and the UE 650, respectively.

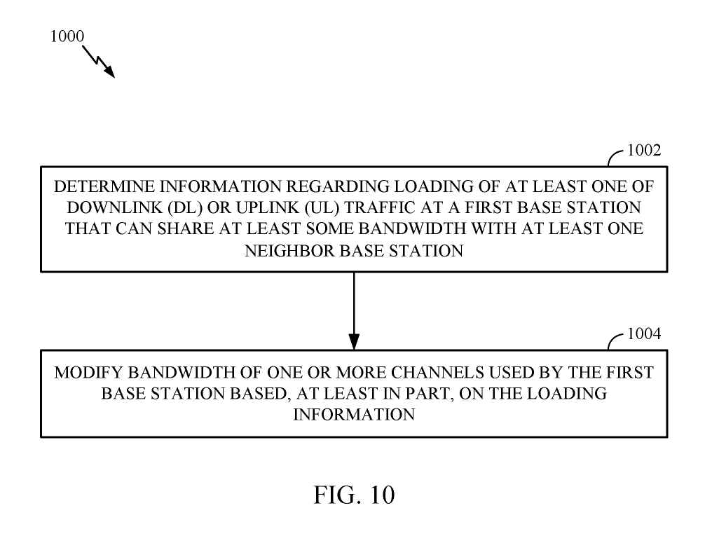

The controller/processor 675 and/or other processors, components and/or modules at the eNB 610 or the controller/processor 659 and/or other processors, components and/or modules at the UE 650 may perform or direct operations, for example, operations 1000 in FIG. 10, and/or other processes for the techniques described herein for expanding and shrinking a bandwidth used by a base station in. In certain aspects, one or more of any of the components shown in FIG. 6 may be employed to perform example operations 1000, and/or other processes for the techniques described herein. The memories 660 and 676 may store data and program codes for the UE 650 and eNB 610 respectively, accessible and executable by one or more other components of the UE 650 and the eNB 610.

### Example Authorized Shared Access for 3.5 GHz

Due to the explosive growth in mobile broadband traffic and its concomitant strain on limited spectrum resources, the Federal Communications Commission has adopted rules to allow commercial shared use of 150 MHz of spectrum in the 3550-3700 MHz (3.5 GHz) band for licensed and unlicensed use of the 3.5 GHz band for a wide variety of services.

Citizens Broadband Radio service (CBRS) is a tiered commercial radio service in 3.5 GHz in the U.S. A Spectrum Access System (SAS) may allocate channels within and across tiers. These tiers can include, in order of priority, (1) incumbent licensees; (2) Priority Access licensees (PALs); and (3) General Authorized Access (GAA) operators.

Authorized shared access (ASA) allocates, to a secondary user(s), portions of spectrum that are not continuously used by an incumbent system(s). The incumbent system may be referred to as an incumbent licensee, Tier 1 operator, primary licensee, or a primary user that is given a primary license for a band of frequencies. The incumbent system may not use the entire frequency band in all locations and/or at all times. The secondary user may be referred to as a secondary licensee or a secondary network. Aspects of the present disclosure are directed to an ASA implementation. Still, the ASA technology is not limited to the illustrated configurations as other configurations are also contemplated. The ASA spectrum refers to portion(s) of a spectrum that is not used by a primary user and has been licensed for use by a secondary user, such as an ASA operator. ASA spectrum availability may be specified by location, frequency, and/or time. It should be noted that the authorized shared access may also be referred to as licensed shared access (LSA).

A PAL is an authorization to use a channel (e.g., an unpaired 10 MHz channel) in the 3.5 GHz range in a geographic service area for a period (e.g., 3 years). The PAL geographic service area may be census tracts, which typically align with the borders of political boundaries such as cities or counties. PAL licensees can aggregate up to four PA channels in any census tract at any given time, and may obtain licenses in any available census tract. PALs may provide interference protection for Tier 1 incumbent licensees and accept interference from them; however, PALs may be entitled to interference protection from GAA operators.

The third tier, GAA, permits access to bandwidth (e.g., 80 MHz) of the 3.5 GHz band that is not assigned to a higher tier (i.e., incumbent licensees or PALs). GAA may be licensed “by rule,” meaning that entities that qualify to be FCC licensees may use FCC-authorized telecommunications equipment in the GAA band without having to obtain an individual spectrum license. GAA operators may receive no interference protection from PALs or Tier 1 operators, and may accept interference from them.

In order to facilitate the complex CBRS spectrum sharing process, a Spectrum Access System (“SAS”), which may be a highly automated frequency coordinator, can be used to assign frequencies in the 3.5 GHz band. The SAS can also authorize and manage use of the CBRS spectrum, protect higher tier operations from interference, and maximize frequency capacity for all CBRS operators.

### Example ASA Architecture

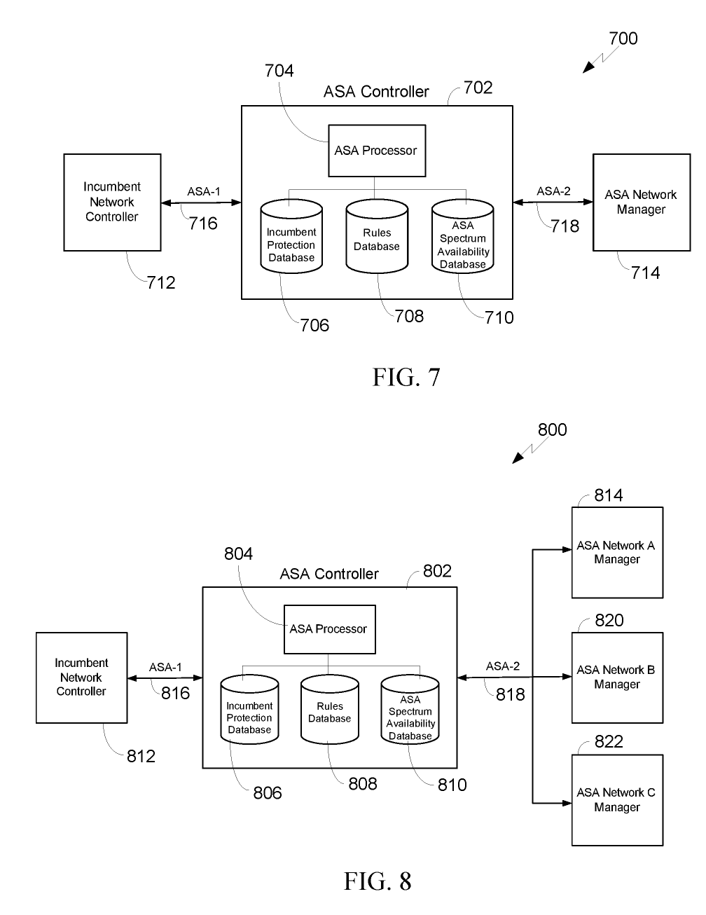

In one configuration, as shown in FIG. 7, an ASA architecture 700 includes an ASA controller 702 coupled to an incumbent network controller 712 of a primary user and an ASA network manager 714 of an ASA network. The primary user may be a primary ASA licensee and the ASA network may be a secondary user.

In one configuration, the incumbent network controller is a network entity operated by the primary user that controls and/or manages the network operating in the ASA spectrum. Furthermore, the ASA network manager may be a network entity operated by the ASA network operator that controls and/or manages an associated network, including but not limited to the devices operating in the ASA spectrum. Additionally, the secondary licensee may be a wireless network operator that has obtained an ASA license to use the ASA spectrum. Furthermore, in one configuration, the ASA controller is a network entity that receives information from the incumbent network controller on the available ASA spectrum that may be used by an ASA network. The ASA controller may also transmit control information to the ASA network manager to notify the ASA network manager of the available ASA spectrum.

In the present configuration, the incumbent network controller 712 is aware of the use of the ASA spectrum by the primary user at specified times and/or locations. The incumbent network controller 712 may provide information to the ASA controller 702 for the incumbent usage of the ASA spectrum. There are several methods that the incumbent network controller 712 can use to provide this information to the ASA controller 702. In one configuration, the incumbent network controller 712 provides a set of exclusion zones and/or exclusion times to the ASA controller 702. In another configuration, the incumbent network controller 712 specifies a threshold for allowed interference at a set of locations. The threshold for allowed interference may be referred to as incumbent protection information. In this configuration, the incumbent protection information is transmitted to the ASA controller 702 over an ASA-1 interface 716. Incumbent protection information may be stored by the ASA controller 702 in incumbent database 706.

The ASA-1 interface refers to the interface between the primary user and the ASA controller. The ASA-2 interface refers to the interface between the ASA controller and the ASA network management system. Moreover, the ASA-3 interface refers to the interface between the ASA network manager and the ASA network elements. Furthermore, geographic sharing refers to an ASA sharing model in which the ASA network can operate throughout a geographic region for an extended period of time. The network is not permitted to operate in regions specified by exclusion zones.

The ASA controller 702 uses the information from the incumbent network controller 712 to determine the ASA spectrum that may be used by the ASA network. That is, the ASA controller 702 determines the ASA spectrum that may be used for a specific time and/or a specific location based on rules specified in a rules database 708. The rules database 708 may be accessed by an ASA processor 704 and stores the regulatory rules that are set by local regulations. These rules may not be modified by the ASA-1 or the ASA-2 interfaces, and may be updated by the individual or organization that manages the ASA controller 702. The available ASA spectrum, as calculated by the rules in the rules database 708, may be stored in the ASA spectrum availability database 710.

The ASA controller 702 may send information to the ASA network manager 714 on the available ASA spectrum via an ASA-2 interface 718, based on the spectrum availability database. The ASA network manager 714 may know or determine the geographic location of base stations under its control and also information about the transmission characteristics of these base stations, such as transmit power and/or supported frequencies of operation. The ASA network manager 714 may query the ASA controller 702 to discover the available ASA spectrum in a given location or a geographic region. Also, the ASA controller 702 may notify the ASA network manager 714 of any updates to the ASA spectrum availability in real-time. This allows the ASA controller 702 to notify the ASA network manager 714 if the ASA spectrum is no longer available, so that the ASA network can stop using that spectrum and the incumbent network controller 712 can obtain exclusive access to the ASA spectrum in real time.

The ASA network manager 714 may be embedded in a standard network element, depending on the core network technology. For example, if the ASA network is a long term evolution (LTE) network, the ASA network manager can be embedded in an operations, administration, and maintenance (OAM) server.

In FIG. 8, an incumbent network controller and a single ASA network manager are illustrated as being coupled to the ASA controller. It is also possible for multiple ASA networks (e.g., ASA network A, ASA network B and ASA network C) to be connected to an ASA controller 802, as in a system 800 shown in FIG. 8. ASA network A includes an ASA network A manager 814 coupled to the ASA controller 802, ASA network B includes an ASA network B manager 820 coupled to the ASA controller 802, and ASA network C includes an ASA network C manager 822 coupled to the ASA controller 802.

In this example, the multiple ASA networks may share the same ASA spectrum. The ASA spectrum may be shared via various implementations. In one example, the ASA spectrum is shared for a given region, so that each network is restricted to a subband within the ASA spectrum. In another example, the ASA networks share the ASA spectrum by using timing synchronization and scheduling the channel access of the different networks.

The system 800 may further include an incumbent network controller 812 of a primary user communicating with the ASA controller 802 via an ASA-1 interface 816, to provide incumbent protection information for incumbent protection database 806. The ASA controller 802 may include a processor 804 coupled to a rules database 808 and ASA spectrum availability database 810. The ASA controller 802 may communicate with the ASA network managers 814, 820 and 822 via an ASA-2 interface 818. The ASA networks A, B, C may be secondary users.

The ASA network manager(s) may interact with various network elements, such as eNodeBs, to achieve the desired spectrum use control. The interaction may be implemented via the ASA-3 interface between eNodeBs in the RAN and an ASA network manager node embedded in an operations, administration, and maintenance server. The RAN may be coupled to a core network. An ASA controller may be coupled to the operations, administration, and maintenance server via an ASA-2 interface and to a network controller of a primary user via an ASA-1 interface.

In some cases, multiple incumbent network controllers are specified for the same ASA spectrum. That is, a single incumbent network controller may provide information about incumbent protection for a given ASA frequency band. Therefore, the architecture may be limited to a single incumbent network controller. However, it is noted that multiple incumbent network controllers may be supported. Still, it may be desirable to limit the network to a single incumbent network controller.

Spectrum sharing systems, such as SAS, allow for radio resources (e.g., operating frequency, power limits, and geographic areas) to be assigned dynamically among multiple users and service providers while providing some degree of protection of other users/service providers and incumbent users that potentially have higher priority (e.g., fixed satellite systems, WISPs, and government/military systems).

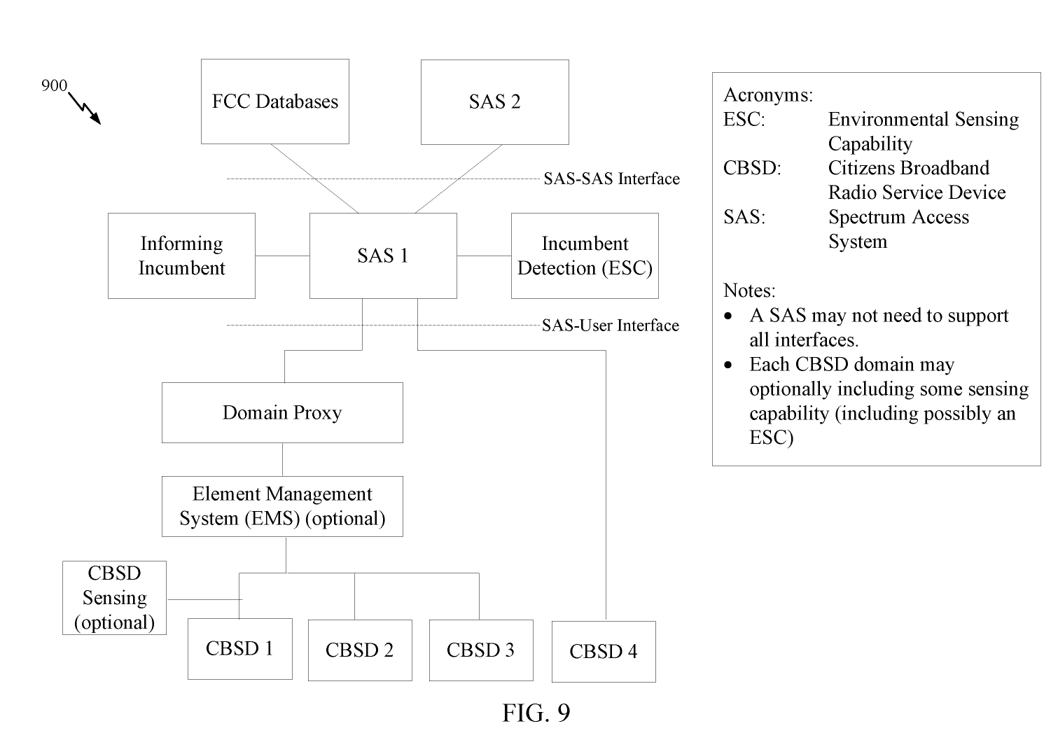

FIG. 9 illustrates an example architecture 900 of a spectrum sharing system. As illustrated, the spectrum sharing system may comprise one or more Spectrum Access Servers (SASs) (e.g., an ASA Controller) which are the entities that accept requests for radio resources from one or more Citizens Broadband Radio Service Devices (CBSDs), resolve conflicts or over-constraints in those requests, and grant the use of resources to radio access services.

When competing users and radio systems, (e.g., CBSDs) vie for radio resources, there is also a challenge of protecting these radio resources from each other based on restrictions due to the radio access technologies that are being used and a number of operational aspects for those radio access technologies. For example, some users/system operators may be able to coexist in the same or neighboring radio channels based on their use of the same (or compatible) radio technologies, compatible Self Organizing Network technologies, synchronized timing, common operational parameters (e.g., TDD slot structures, common radio silence intervals, etc.), and access to the same Core Networks for seamless mobility, etc.

### Example Bandwidth Expansion in Co-Channel Coexistence

In some cases, bandwidth expansion may be used to dynamically share channels with multiple operators in a network. For example, shared channels may be used for General Authorized Access (GAA) operation in certain bands (e.g., the 3.5 GHz band). In some cases, the number of channels available may exceed the number of operators (e.g., base stations) in a given location. With each base station having a separate primary channel, some unused channels (or secondary channels) may exist. Because a number of unused channels may exist, base stations can potentially expand its bandwidth in response to increased traffic loading at the base stations by using one or more of the unused channels (or secondary channels). In some cases, a base station can take an available adjacent channel, if one exists, to increase the operational bandwidth to the combination of the base station's primary channel and the adjacent channel. In some cases, where a base station supports carrier aggregation, the base station may expand its bandwidth using any available channel.

FIG. 10 illustrates example operations 1000 for modifying a bandwidth used by a first base station, in accordance with certain aspects of the present disclosure. According to certain aspects, example operations 1000 may be performed, for example, by a base station (e.g., one or more of the base stations illustrated in FIG. 2).

Operations 1000 begin at 1002, where a base station determines information regarding loading of at least one of downlink (DL) or uplink (UL) traffic at a first base station. The first base station can share at least some bandwidth with at least one neighbor base station. At 1004, the base station modifies bandwidth of one or more channels used by the first base station based, at least in part, on the loading information.

As discussed, expansion and shrinkage of bandwidth at a base station may be a function of one or both of DL and UL loading information. The loading information may include, for example, resource block (RB) utilization at the base station, an amount of buffered data at the base station, an average queueing time for packets at the base station, and so on. To determine when a base station can expand or shrink bandwidth, resource utilization may be compared to a threshold value. If traffic loading at a base station (e.g., RB utilization, amount of buffered data, average packet queueing time, and so on) exceeds a high loading threshold value, bandwidth expansion may be triggered to allow the base station to expand its operational bandwidth to one or more secondary channels that are available for use by the base station (e.g., that are not currently being used by one or more neighbor base stations). If traffic loading at the base station falls below a low loading threshold value, bandwidth shrinkage may be triggered to release a secondary channel used by the base station for use by neighbor base stations. In such a case, bandwidth shrinkage may be triggered when the bandwidth used by a base station includes a primary channel and one or more secondary channels (e.g., where a base station has previously expanded its operational bandwidth to include one or more secondary channels in response to increased traffic loading at the base station but no longer needs to use at least some of the secondary channels to provide service to one or more UEs).

In some cases, expansion and/or shrinkage of bandwidth used by a base station may further be based on the bandwidth and/or traffic loading information for one or more neighbor base stations. To support bandwidth expansion and/or shrinkage based on information from neighbor base stations, base stations may coordinate with each other (within or across network operators). Coordination may occur between base stations, for example, using an X2 interface between base stations.

In some cases, a base station can determine whether to claim additional secondary channels for bandwidth expansion based, at least in part, on bandwidth information and traffic loading information for the base station and one or more neighbor base stations. A base station may claim additional secondary channels for bandwidth expansion, for example, if the base station has a smaller bandwidth than neighbor base stations or when the base station has a larger amount of traffic loading (e.g., RB utilization) than neighbor base stations. The base station may defer to other base stations in claiming unused secondary channels or shrink its bandwidth, for example, when the base station has a larger bandwidth than neighbor base stations or when the base station has less traffic loading than neighbor base stations. In some cases, a base station may shrink its bandwidth if communications using the expanded bandwidth is causing interference to a neighbor base station.

In some cases, a base station can consider interference information in determining which secondary channels to use or release for bandwidth expansion or shrinkage. For example, a base station can expand its bandwidth by adding one or more channels to its operational bandwidth. For example, adding one or more channels may entail selecting, from a group of secondary channels, the secondary channel that is experiencing or causing the least amount of interference to neighbor base stations in proximity to the base station. In some cases, if interference on all of the secondary channels exceeds a threshold level of interference, the base station need not select a channel for bandwidth expansion. When shrinking bandwidth, the base station can release the secondary channel with the largest amount of interference from the group of secondary channels associated with the base station.

After a base station selects one or more secondary channels for bandwidth expansion, the base station can operate on the combination of the base station's primary channel and the selected one or more secondary channels. Subsequent corrections or modifications to the group of channels used by the base station may be performed based on additional information, such as interference information received from a user equipment (UE). For example, a UE may report reference signal received quality (RSRQ), a channel quality indicator (CQI), block error rate (BLER), and so on to a serving base station on a per-channel basis. In some cases, such information may be available on a per-channel basis for base stations operating in a carrier aggregation mode. Upon detecting that an interference metric (e.g., RSRQ, CQI, BLER, and the like) for a secondary channel exceeds a threshold value, the base station can adjust its operational bandwidth by removing the secondary channel from the group of channels associated with the base station. The removed secondary channel may subsequently be claimed by a neighbor base station for bandwidth expansion, as discussed above (e.g., by a neighbor base station having a traffic loading exceeding a high traffic threshold).

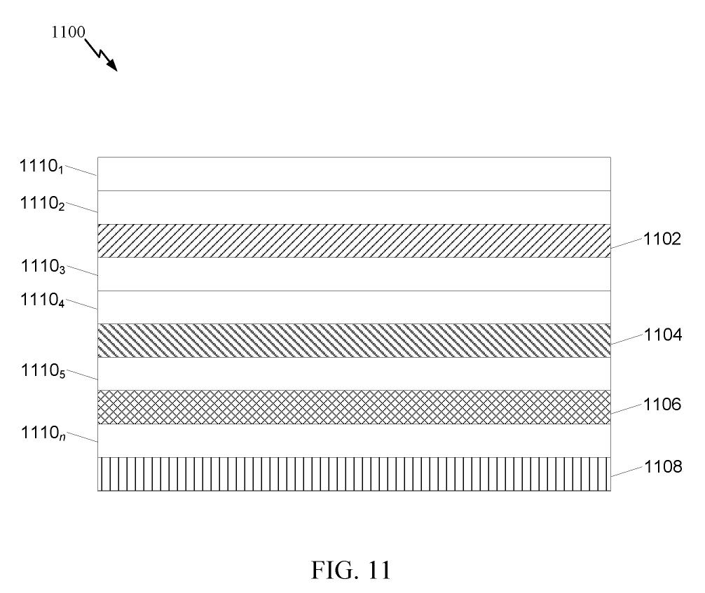

FIG. 11 illustrates an example bandwidth configuration 1100 for nodes of different operators, in accordance with certain aspects of the present disclosure. As illustrated, four base stations operate on a primary channel 1102, 1104, 1106, and 1108 unique to each of the base stations. Secondary channels 1110 generally include channels that are unallocated to a base station as a primary channel and can be claimed by any of the four base stations operating in the area. In a scenario where a base station can claim adjacent channels for bandwidth expansion, for example, a first base station operating on primary channel 1102 can initially claim one or both of secondary channels 1110₂ and 1110₃ for bandwidth expansion, a second base station operating on primary channel 1104 can claim one or both of secondary channels 1110₄ and 1110₅ for bandwidth expansion, and so on. In a scenario where a base station (e.g., a third base station operating on primary channel 1106) is capable of carrier aggregation, that base station can choose any unused secondary channel 1110 for bandwidth expansion. As discussed above, based on traffic loading and/or interference information for each of the base stations, secondary channels 1110 can be released and reallocated over time.

### Example Interference Maps for Efficient Spectrum Sharing

In some cases, multiple operators may share the GAA spectrum in a given geographical area. Each operator may provide service to its own subscribers but need not provide service to users served by other operators. In a case where the primary channel, or protected channel, of two operators with overlapping coverage areas are the same, a strong interference situation may exist between the two operators, which may result in the existence of an outage area for at least some of the operators in a geographical area that share the GAA spectrum.

When competing users and/or radio systems (e.g., CBSDs) vie for radio resources, there is also a challenge of protecting these radio resources from competing users and/or radio systems based, for example, on restrictions due to the radio access technologies that are being used and a number of operational aspects for those radio access technologies. For example, some users or system operators may be able to coexist in the same or neighboring radio channels based on their use of the same (or compatible) radio technologies, compatible Self Organizing Network (SON) technologies, synchronized timing, common operational parameters (e.g., TDD slot structures, common radio silence intervals, etc.), access to the same Core Networks for seamless mobility, and the like.

To use spectrum efficiently, base stations may be able to expand its bandwidth to use unused channels available in the frequency spectrum. The techniques discussed herein allow for the expansion of bandwidth used by a base station to cover unused spectrum while avoiding interference to the protected spectrum (e.g., the primary channel) of other base stations within proximity of the base station.

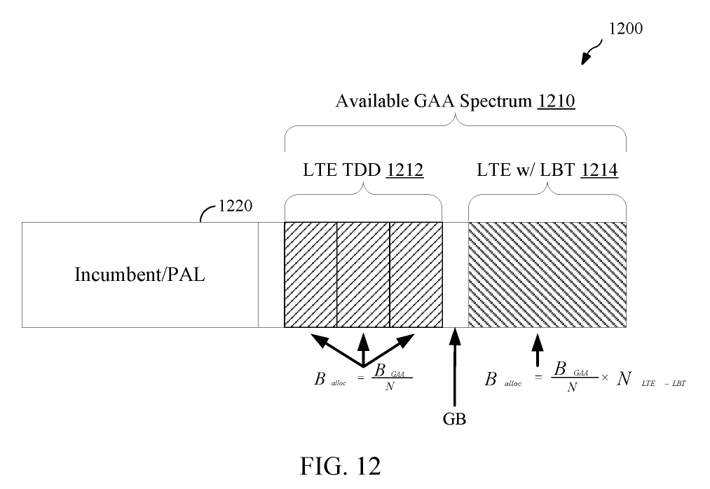

FIG. 12 illustrates an example allocation of bandwidth 1200 to one or more operators in a geographical area, according to an aspect of the present disclosure. As illustrated, the frequency spectrum may include a GAA spectrum 1210 that may be partitioned into a plurality of parts. Each part of GAA spectrum 1210 may be assigned to an operator in the geographical area. The frequency spectrum may include incumbent and/or priority access licensed spectrum 1220 which may be protected from interference from operators in the GAA spectrum.

An SAS may compute the total available bandwidth, B_{GAA}, in the GAA spectrum 1210 for a particular geographical area (e.g., census tract) based on incumbent and PAL protection. B_{GAA} may be divided into a first portion 1212 for operators that use a time-domain-duplexed radio access technology (e.g., LTE-TDD) and a second portion 1214 for operators that use a listen-before-talk radio access technology (e.g., Licensed Assisted Access (LAA), enhanced Licensed Assisted Access (eLAA), MulteFire, and the like). First portion 1212 and second portion 1214 may be separated by a guard band.

In some cases, the available GAA bandwidth, B_{GAA}, may be divided into N partitions, with each partition intended for an operator in the geographical area (e.g., where N represents a number of operators in the geographical area). Each partition assigned to an operator may have a bandwidth of B_{alloc}, which may be represented as B_{GAA}/N. Second portion 1214 may occupy an amount of the GAA spectrum denoted as B_{GAA}/N× N_{LTE-LBT}, where N_{LTE-LBT} represents the number of operators in the geographical area that use a LBT-based radio access technology. Each operator may expand its own bandwidth beyond its allocated B_{alloc} so long as the expansion of bandwidth does not interfere with the allocated spectrum of other operators in the GAA spectrum for the geographical area. Operators may, but need not receive a contiguous partition, as the B_{alloc}-sized bandwidth may be formed from a plurality of noncontiguous portions of the GAA spectrum.

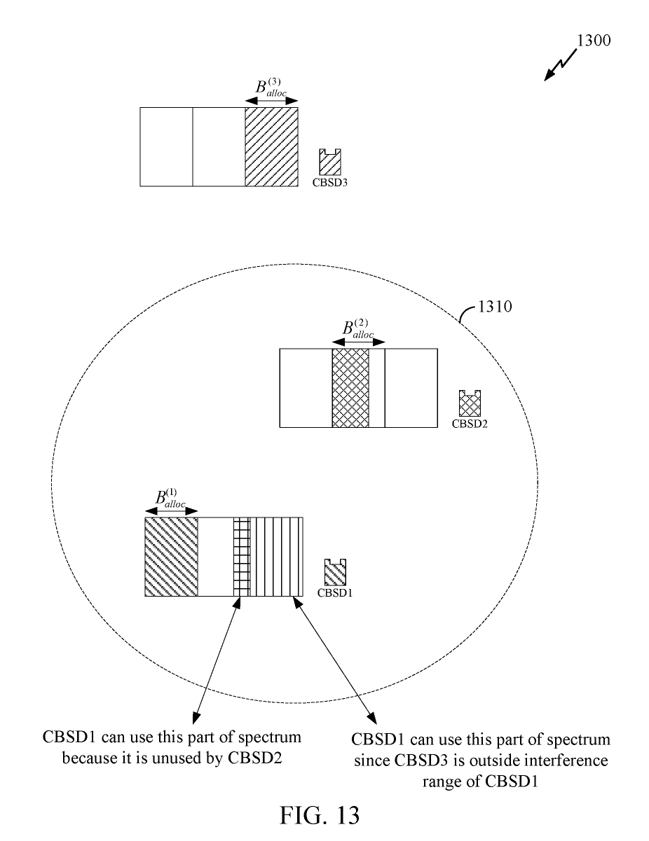

In some cases, each CBSD may determine how much of its allocated bandwidth, B_{alloc}, (primary/protected spectrum) to use, and each CBSD may expand its bandwidth to unused portions of another operator's spectrum allocation. For example, as illustrated in FIG. 13, a CBSD may expand its bandwidth beyond its allocation of B_{alloc} based on spectrum usage within the CBSD's coverage area. As illustrated, network 1300 may include three CBSDs, CBSD1, CBSD2, and CBSD3. CBSD1 may have a coverage area of 1310, which may encompass CBSD2. CBSD3 is illustrated as outside of coverage area 1310.

As illustrated, CBSD2 need not use its allocated spectrum, B_{alloc}, in its entirety. Because CBSD2 need not use the entirety of its allocated spectrum, CBSD1 may expand its bandwidth to include the unused portion of the frequency spectrum allocated to CBSD2. Further, because CBSD3 is outside the interference range of CBSD1, CBSD1 can additionally expand its bandwidth to include the portion of the frequency spectrum allocated to CBSD3. Bandwidth expansion need not result in a CBSD using a contiguous frequency range; for example, the primary bandwidth of the CBSD and the frequency spectrum used for bandwidth expansion may be separated by a portion of frequency spectrum used by other CBSDs.

Network devices may have varied roles in providing for operator coexistence in shared spectrum. A spectrum access system (SAS) may allocate the GAA spectrum to different operators in a given area as the operator's primary spectrum. A coexistence module (CXM) may coordinate exchange of co-existence related information between CBSDs for bandwidth protection and/or expansion. An SAS and/or a CXM may be referred to generally as “central network entities.” The CBSDs may provide coexistence information to the SAS and CXM and may select channels to operate on and a transmission power based on data provided by the SAS and/or CXM and bandwidth protection/expansion rules.

In some cases, a CXM may be a component of an SAS or a separate entity. If a CXM is implemented as part of an SAS, SAS-SAS interfaces and CBSD-SAS interfaces may be extended to cover the transfer of coexistence information between SASs and between an SAS and a CXM. If a CXM is a separate entity, additional interfaces may be defined to provide for CXM-CBSD data exchange (e.g., to provide coexistence data from a CXM to a CBSD) and CXM-CXM data exchange.

A central network entity (e.g., a CXM and/or SAS) may maintain coexistence information for each CBSD. The coexistence information may include, for example, CBSD location, whether the CBSD is deployed in an indoor or outdoor environment, a type of CBSD, compatibility data, primary and other operating channels for the CBSD, a maximum transmit power for the CBSD, compatibility IDs indicating whether a device can operate in a coexistence environment, and so on. The central network entity (CXM and/or SAS) may build an interference map based on the coexistence information and share the interference map with CBSDs. The interference map may include, for example, a power spectral mask, or transmission power map. The transmission power map may be specific to a particular CBSD and indicate an allowable transmission power by the particular CBSD for portions of the frequency spectrums assigned to different operators (e.g., a transmission power limit per channel) to reduce or minimize interference caused by the CBSD to other CBSDs (e.g., of other operators). The transmission power map may protect the primary bandwidth of neighboring CBSDs (e.g., by indicating a low or no maximum transmission power for other CBSDs) and may allow a CBSD to expand its bandwidth using the primary or non-primary spectrum of other CBSDs. In some cases, a CBSD may expand its bandwidth to the primary or non-primary spectrum of other CBSDs using a transmission power that is less than or equal to the transmission power limit indicated in the transmission power map.

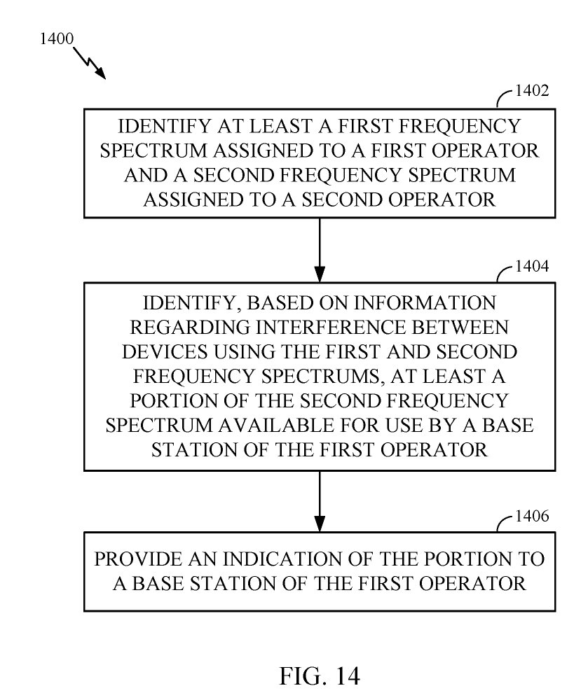

FIG. 14 illustrates example operations 1400 that may be performed by a network entity to manage interference between operators, according to an aspect of the present disclosure. As illustrated, operations 1400 begin at 1402, where a network entity identifies at least a first frequency spectrum assigned to a first operator and a second frequency spectrum assigned to a second operator.

At 1404, the network entity identifies, based on interference regarding interference between devices using the first and second frequency spectrums, at least a portion of the second frequency spectrum available for use by a base station of the first operator.

At 1406, the network entity provides an indication of the portion to a base station of the first operator. In some cases, the indication may include an interference map generated based, at least in part, on propagation information or models and RF measurements obtained from one or more network entities (e.g., UEs and/or base stations). As discussed above, the indication may include, in some cases, a transmission power map indicating allowable transmission power for portions of frequency spectrums assigned to different operators.

In some cases, the coexistence information may be shared between CBSDs in a given area, and each CBSD may determine, based on the coexistence information, whether the CBSD will cause interference to other CBSDs on each channel.

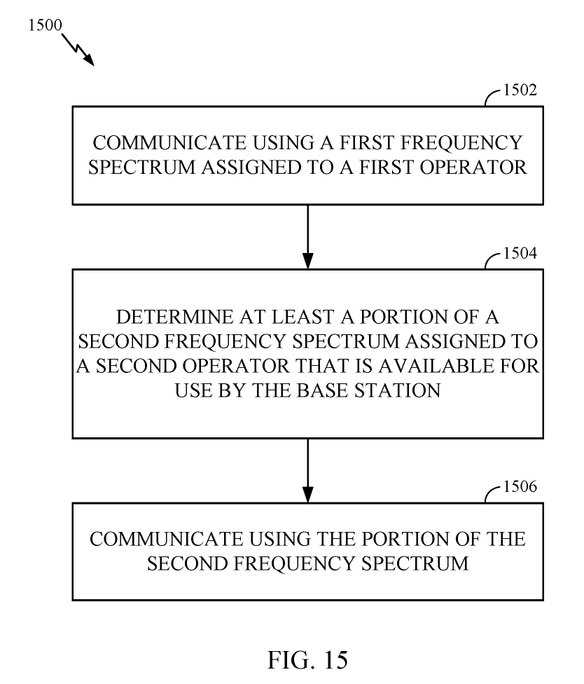

FIG. 15 illustrates example operations 1500 that may be performed by a base station of a first operator for bandwidth expansion, according to an aspect of the present disclosure. As illustrated, operations 1500 begin at 1502, where the base station communicates using a first frequency spectrum assigned to the first operator.

At 1504, the base station determines at least a portion of a second frequency spectrum assigned to the second operator that is available for use by the base station. The determination may be based, for example, on an indication of the portion of the second frequency spectrum, which may be received, for example, from a central network entity (e.g., an SAS and/or CXM). In some cases, the base station can determine at least a portion of the second frequency spectrum that is available for use by the base station based on information regarding interference between devices using the first and second frequency spectrums gathered at the base station. The interference information may be obtained for example, from one or more UEs served by the base station or one or more base stations operating in the second frequency spectrum (via a backhaul link). In some cases, the base station may receive the information regarding interference as a transmission power map indicating allowable transmission power for portions of the frequency spectrums assigned to different operators.

At 1506, the base station communicates using the portion of the second frequency spectrum.

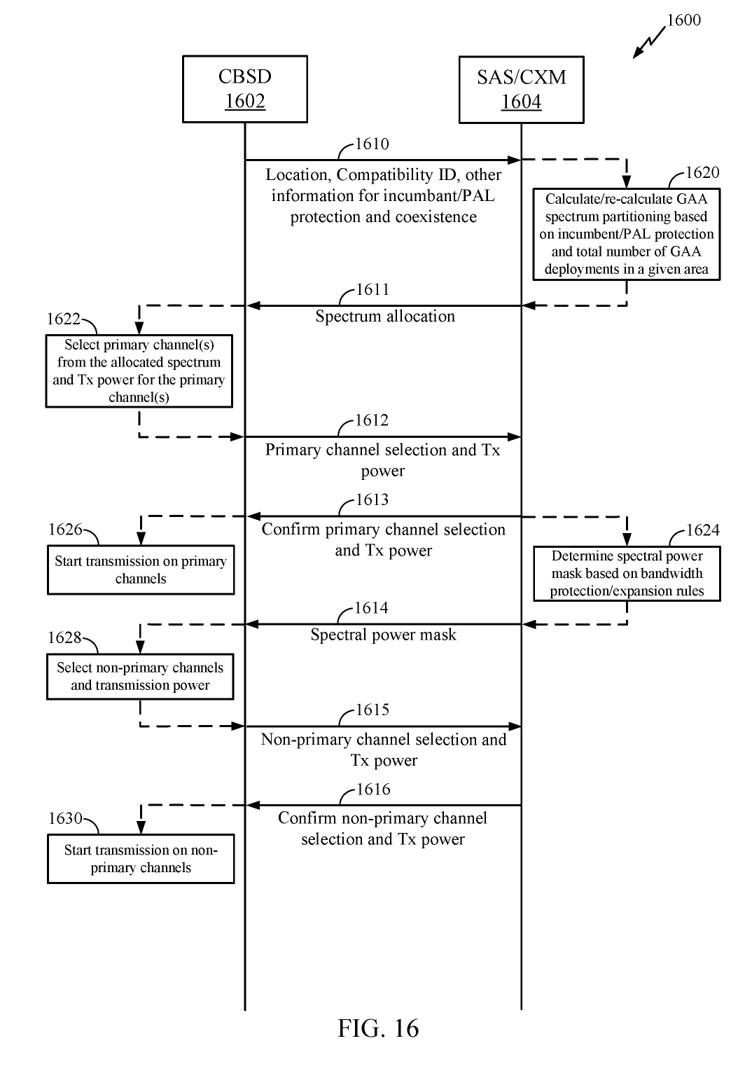

FIG. 16 illustrates an example message flow 1600 between a CBSD 1602 and a collocated spectrum access system (SAS)/coexistence manager (CXM) 1604 for determining a portion of a frequency spectrum to use by the CBSD in communications with one or more connected UEs, according to an aspect of the present disclosure. As illustrated, CBSD 1602 sends message 1610 to SAS/CXM 1604. Message 1610 may include, for example, location data, compatibility information, and other information for incumbent/PAL protection and GAA coexistence. At 1620, based on the information received in message 1610, SAS/CXM 1604 calculates (or, if a CBSD is added to a network, recalculates) GAA spectrum partitioning based on incumbent/PAL protection and a total number of GAA deployments in a given geographical area. As discussed above, the GAA spectrum partitioning may be calculated or re-calculated as the amount of bandwidth available for devices operating in the GAA spectrum, divided by the number of GAA deployments in the geographical area (i.e., B_{alloc}=B_{GAA}/N). The SAS/CXM sends message 1611 to CBSD 1602 including the spectrum allocation.

At 1622, using the spectrum allocation received in message 1611, CBSD 1602 may select one or more primary channels from the allocated spectrum and a transmission power to be used for transmissions on the selected one or more primary channels. Information about the selected primary channels and transmission power is transmitted in message 1612 from CBSD 1602 to SAS/CXM 1604, which confirms the selected primary channels and transmission power in a message 1613 to CBSD 1602. At CBSD 1602, upon receiving message 1613 confirming the primary channel selection and transmission power, at 1626, CBSD 1602 may commence transmission on the selected primary transmissions.

SAS/CXM 1604, at 1624, determines a spectral power mask (e.g., a transmission power map) based on bandwidth protection and expansion rules. The determined spectral power mask is transmitted to CBSD 1602 in message 1614 for use at 1628, where CBSD 1602 selects one or more non-primary channels and a transmission power to be used for transmissions on the selected non-primary channels. CBSD 1602 can inform SAS/CXM 1604 of the selected one or more non-primary channels and transmission power via message 1615 and receive a confirmation message 1616 from SAS/CXM 1604 that CBSD 1602 can use the selected non-primary channels and transmission power. Upon receiving a confirmation from SAS/CXM 1604, at 1630, CBSD 1602 can begin transmitting on the primary and non-primary channels.

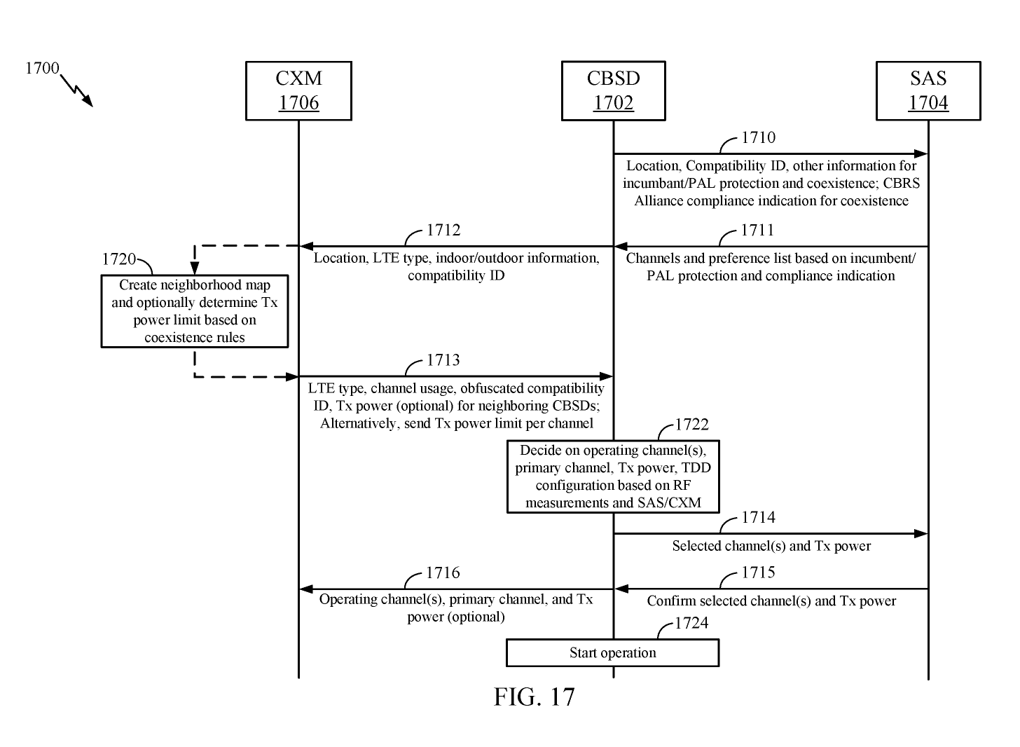

FIG. 17 illustrates an example message flow 1700 between a CBSD 1702, a spectrum access system (SAS) 1704, and a coexistence manager (CXM) 1706 for determining a portion of a frequency spectrum to use by CBSD 1702 in communications with one or more connected UEs, according to an aspect of the present disclosure. As illustrated, CBSD 1702 can transmit a message 1710 to SAS 1704 including location information and other information needed by SAS 1704 for incumbent and/or PAL protection, as well as an indication of whether CBSD 1702 supports GAA coexistence. In response, SAS 1704 transmits, to CBSD 1702, message 1711 including a set of channels and a preference list based on incumbent and/or PAL protection and the indication of whether CBSD 1702 supports GAA coexistence.

CBSD 1702 subsequently transmits message 1712 to CXM 1706. Message 1712 generally includes location information, radio access technology, indoor/outdoor information, and compatibility ID data that, at 1720, CXM 1706 can use to create a neighborhood map (e.g., a transmission power map). In some cases, CXM 1706 may determine transmission power limits on a per-channel basis based on coexistence rules.

After creating the neighborhood map, CXM 1706 may transmit interference information to CBSD 1702 in message 1713. The interference information may include, for example, channel usage, compatibility IDs, and transmission power for neighboring CBSDs. In some cases, the interference information may include a transmission power limit on a per-channel basis.

At 1722, using the interference data and other RF measurements received from CXM 1706 in message 1713, CBSD 1702 determines operating channels, a primary channel, transmission power, and time domain duplexing (TDD) configuration. CBSD 1702 transmits a message 1714 including the selected channels and transmission power to SAS 1704, which confirms, via message 1715, that CBSD 1702 can communicate using the selected channels and transmission power. CBSD 1702 can transmit message 1716 to CXM 1706 including information about the operating channels, primary channel, and transmission power and, at 1724, begin communications using the selected channels and transmission power.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “identifying” encompasses a wide variety of actions. For example, “identifying” may include calculating, computing, processing, deriving, investigating, looking up (e.g., looking up in a table, a database or another data structure), ascertaining and the like. Also, “identifying” may include receiving (e.g., receiving information), accessing (e.g., accessing data in a memory) and the like. Also, “identifying” may include resolving, selecting, choosing, establishing and the like.

In some cases, rather than actually communicating a frame, a device may have an interface to communicate a frame for transmission or reception. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The various operations of methods described above may be performed by any suitable means capable of performing the corresponding functions. The means may include various hardware and/or software/firmware component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

For example, means for determining, means for performing, means for transmitting, means for receiving, means for sending, means for signaling, means for selecting, means for correlating, means for scaling, means calculating, means for averaging, and/or means for taking action, may include one or more processors, transmitters, receivers, and/or other elements of the user equipment 102 and/or the base stations 106 or 108 illustrated in FIG. 2.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

Those of skill would further appreciate that the various illustrative logical blocks, modules, circuits, and algorithm steps described in connection with the disclosure herein may be implemented as electronic hardware, software/firmware, or combinations thereof. To clearly illustrate this interchangeability of hardware and software/firmware, various illustrative components, blocks, modules, circuits, and steps have been described above generally in terms of their functionality. Whether such functionality is implemented as hardware or software/firmware depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software/firmware module executed by a processor, or in a combination thereof. A software/firmware module may reside in RAM memory, flash memory, ROM memory, EPROM memory, EEPROM memory, phase change memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software/firmware, or combinations thereof. If implemented in software/firmware, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD/DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software/firmware is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
determining information regarding loading of at least one of downlink (DL) or uplink (UL) traffic at a first base station that can share at least some bandwidth with at least one neighbor base station; and
modifying bandwidth of one or more channels used by the first base station based, at least in part, on the loading information.

2. The method of claim 1, wherein the modifying comprises:
expanding the bandwidth by adding one or more secondary channels to a group of channels associated with the first base station; or
shrinking the bandwidth by removing one or more secondary channels from the group of channels.

3. The method of claim 1, wherein the determining comprises:
comparing an amount of loading to a threshold value.

4. The method of claim 1, wherein modifying the bandwidth is further based on loading information of the neighbor base station.

5. The method of claim 4, wherein the modifying comprises:
expanding the bandwidth upon determining that an amount of loading at the first base station exceeds an amount of loading at the neighbor base station; or
shrinking the bandwidth upon determining that the amount of loading at the first base station is less than loading at the neighbor base station.

6. The method of claim 1, wherein modifying the bandwidth is further based on one or more of:
an amount of bandwidth used by the neighbor base station; or
bandwidth usage at the first base station and the neighbor base station.

7. The method of claim 1, wherein:
the one or more channels comprises at least one secondary channel; and
modifying the bandwidth is further based on interference information associated with the secondary channel.

8. A method for managing interference between operators, comprising:
identifying at least a first frequency spectrum assigned to a first operator and a second frequency spectrum assigned to a second operator;
identifying, based on information regarding interference between devices using the first and second frequency spectrums, at least a portion of a second frequency spectrum available for use by a base station of the first operator; and
providing an indication of the portion of the second frequency spectrum to a base station of the first operator.

9. The method of claim 8, wherein at least one of the first frequency spectrum or second frequency spectrum comprise one or more non-contiguous frequency bands.

10. The method of claim 8, further comprising:
gathering information regarding interference between devices using the first and second frequency spectrums, wherein the identifying at least the portion of the second frequency spectrum is based, at least in part, on the gathered information.

11. The method of claim 10, wherein the information is obtained from one of:
one or more user equipments (UEs) served by one or more base stations of the first operator and one or more base stations of the second operator, or
one or more base stations operating in the first frequency spectrum or second frequency spectrum.

12. The method of claim 8, wherein the indication comprises a transmission power map specific to the base station of the first operator, the transmission power map indicating allowable transmission power for portions of frequency spectrums assigned to different operators to reduce interference to devices served by the different operators

13. The method of claim 8, wherein the information comprises at least one of: a location of a device, an indication whether a device is deployed in an indoor or outdoor environment, a type of device, compatibility information, operating channel information, or transmission power.

14. A method of wireless communications by a base station of a first operator, comprising:
communicating using a first frequency spectrum assigned to the first operator;
determining at least a portion of a second frequency spectrum assigned to a second operator that is available for use by the base station; and
communicating using the portion of the second frequency spectrum.

15. The method of claim 14, wherein at least one of the first frequency spectrum or second frequency spectrum comprise one or more non-contiguous frequency bands.

16. The method of claim 14, further comprising:
receiving an indication of the portion of the second frequency spectrum.

17. The method of claim 14, further comprising:
gathering information regarding interference between devices using the first and second frequency spectrums, wherein the determining is based, at least in part, on the gathered information.

18. The method of claim 17, wherein the information is gathered from one of:
one or more user equipments (UEs) served by the base station or one or more base stations of the second operator,
one or more base stations operating in the first frequency spectrum or second frequency spectrum, or
one or more user equipments (UEs) or base stations operating in the first frequency spectrum or second frequency spectrum via a central network entity.

19. The method of claim 17, wherein the information comprises a transmission power map specific to the base station, the transmission power map indicating allowable transmission power for portions of frequency spectrums assigned to different operators to reduce interference to devices served by the different operators.

20. The method of claim 17, wherein the information comprises at least one of: a location of a device, an indication of whether the device is deployed in an indoor or outdoor environment, a type of the device, compatibility information, operating channel information of the device, or transmission power of the device.
